(19) United States
(12) Patent Application Publication
(10) Pub. No.: US 2009/0025029 A1
(43) Pub. Date: Jan. 22, 2009

(54) Digital channel generation apparatus

(76) Inventors: Meng-Huang Lee, Taipei (TW); Feng-Chieh Chiu, Taipei (TW); Hsu-Tsung Hung, Taipei (TW); Chien-Wen Tai, Taipei (TW); Chen-Hsiu Weng, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,448

(22) Filed: Jul. 16, 2007

(51) Int. Cl. G06F 3/00

(52) U.S. Cl. 725/37

(57) ABSTRACT

A digital channel generation apparatus is provided for easily setting up a digital channel by a user. The digital channel generation apparatus includes a storage unit, a user interface, and a processing unit. The storage unit stores a plurality of set-top box data, a plurality of electronic device data, a plurality of multimedia data, and at least one channel set-up template. The user interface provides the user a functionality of selecting at least one electronic device data from the plurality of electronic device data. Furthermore, the user interface provides the user a functionality of inputting a set-up data of the digital channel based on the channel set-up template. The processing unit coupled to the user interface generates the digital channel for broadcasting the plurality of multimedia data based on the selected electronic device data, the plurality of set-top box data, the channel set-up template and the set-up data.

### BACKGROUND OF THE INVENTION

1. Field of the Invention

The present invention relates in general to a digital channel generation apparatus and, more particularly, to a digital channel generation apparatus for easily setting up a digital channel by a user.

2. Description of the Prior Art

Nowadays, based on the needs of audio-video entertainments by customers and advanced network development, the Multi-media On Demand (MOD) has been intensely developed by the telecommunication, multi-media, and network research staffs. The Multi-media On Demand takes advantage of existing switched telephone networks to provide users a variety of services such as telephoning, television watching, movie enjoying, Kala OK entertaining, and high-speed networking, which can be optionally picked by users at any time.

However, there are lots of different types of MOD set-top boxes, which means that package types of the browser software and the control codes of the remote controllers used by different types of set-top boxes are mostly different. Consequently, while setting up a digital channel for certain set-top box or remote controller, design engineers are required to make corresponding reprogramming for constructing the architecture of the digital channel so that the digital channel can be enjoyed by customers. Therefore, the traditional method for setting up digital channels is almost impossible to be employed by a user who is familiar with how to design the architecture of the digital channel without knowing how to program. Accordingly, the abovementioned traditional method for setting up digital channels can not meet the increasing capacity of MOD consuming market due to the increasing digital services.

For that reason, there is a big need for providing a digital channel generation apparatus for easily setting up a digital channel by a user incapable of programming to solve the aforementioned problems.

### SUMMARY OF THE INVENTION

It is therefore a primary objective of the present invention to provide a digital channel generation apparatus for easily setting up a digital channel by a user incapable of programming.

In accordance with an objective of the present invention, a digital channel generation apparatus for setting up a digital channel by a user is provided. The digital channel generation apparatus comprises a storage unit, a user interface, and a processing unit. The storage unit is utilized for storing a plurality of set-top box data, a plurality of electronic device data, a plurality of multimedia data, and at least one channel set-up template. The user interface coupled to the storage unit provides the user a functionality of selecting at least one electronic device data from the plurality of electronic device data. Furthermore, the user interface provides the user a functionality of inputting a set-up data of the digital channel based on the channel set-up template. The processing unit coupled to the user interface generates the digital channel for broadcasting the plurality of multimedia data based on the selected electronic device data, the plurality of set-top box data, the channel set-up template and the set-up data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above and other objects and features of the present invention will become apparent from the subsequent description of preferred embodiments given in conjunction with the following accompanying drawings.

FIG. 1 is a schematic block diagram showing a digital channel generation apparatus in accordance with the present invention.

FIG. 2 is a schematic block diagram showing a digital channel generation apparatus in accordance with a preferred embodiment of the present invention.

FIG. 3 shows a schematic exemplary structure of the channel set-up template in accordance with the present invention.

FIG. 4A shows the main channel page displaying the main content of the exemplary digital channel of a library.

FIG. 4B shows the information bulletin board page concerning the option of “About The Library”.

FIG. 4C shows the film content page concerning the option of “Film Entertainment”.

FIG. 4D shows the film introduction page concerning the option of “Sun Tzu Military Strategy”.

FIG. 4E shows the electronic photo album concerning the option of “The Library Ages Ago”.

FIG. 5 shows a schematic diagram of the user interface of the digital channel generation apparatus in accordance with a preferred embodiment of the present invention.

FIG. 6 is a schematic diagram showing an exemplary channel page of a mobile phone generated by the digital channel generation apparatus in accordance with the present invention.

### DETAILED DESCRIPTION OF THE PREFERRED EMBODIMENT

Hereinafter, preferred embodiments of the present invention will be described in detail with reference to the accompanying drawings. Here, it is to be noted that the present invention is not limited thereto.

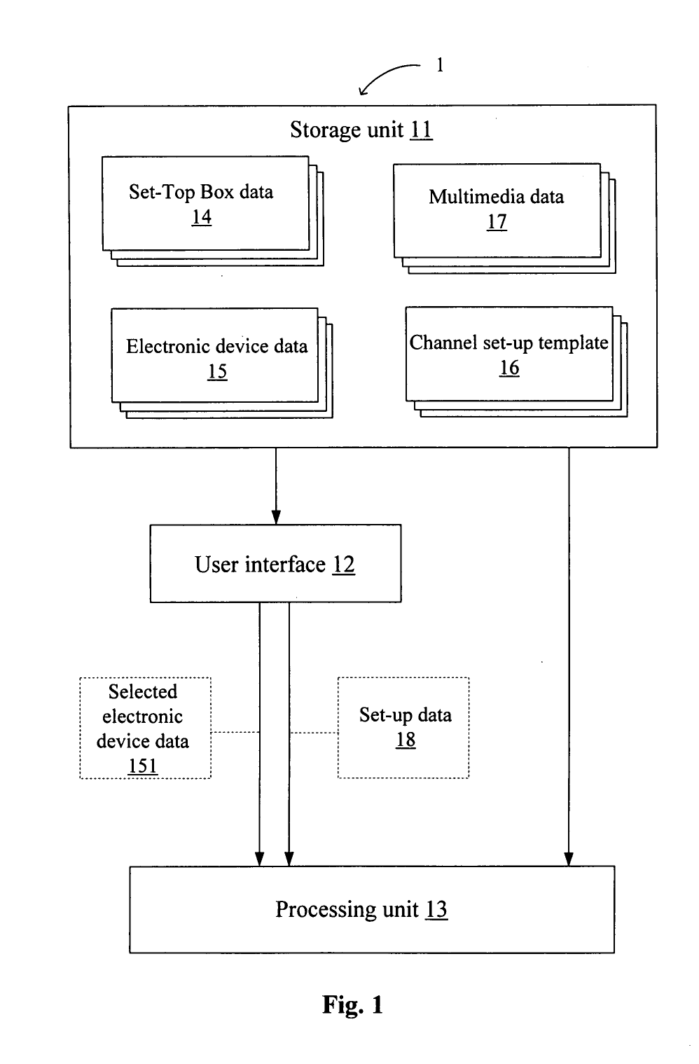

Please refer to FIG. 1. FIG. 1 is a schematic block diagram showing a digital channel generation apparatus in accordance with the present invention. The digital channel generation apparatus 1 comprises a storage unit 11, a user interface 12, and a processing unit 13. The storage unit 11 stores a plurality of set-top box data 14, a plurality of electronic device data 15, a plurality of multimedia data 17, and at least one channel set-up template 16. The set-top box data 14 comprises the model number of the set-top box, the information of the browser (ex: IE or NESCAPE) used by the set-top box, and the information of the remote controller used by the set-top box. The electronic device data 15 comprises the information of display resolution of electronic devices such as the screen resolution of a television, the screen resolution of a computer monitor, or the screen resolution of a hand-held device.

The user interface 12 provides users a functionality of selecting one electronic device data 151 corresponding to an electronic device used by users from the plurality of electronic device data 15. Furthermore, the user interface 12 provides users a functionality of inputting the set-up data 18 of a digital channel based on the channel set-up template 16. The processing unit 13 is able to generate a digital channel for broadcasting the multimedia data 17 based on the selected electronic device data 151, the set-top box data 14, the channel set-up template 16 and the set-up data 18.

While making use of a digital channel generated by the digital channel generation apparatus 1, the digital channel is capable of detecting device model of the set-top box used by users, and selects one of the plurality of set-top box data 14 complied with the set-top box used by users based on the device model of the set-top box. Alternatively, the user interface 12 may provide users a functionality of selecting one of the plurality of build-in set-top box data 14 manually, and the processing unit 13 is able to generate a digital channel for broadcasting the multimedia data 17 based on the selected electronic device data 151, the selected set-top box data, the channel set-up template 16 and the set-up data 18.

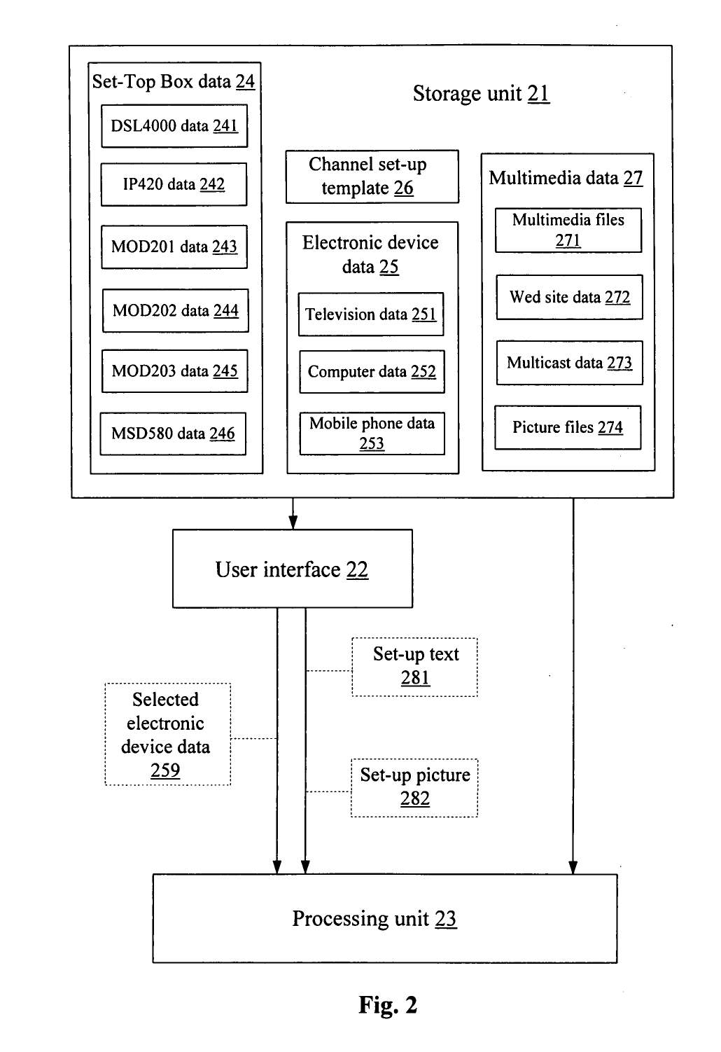

Please refer to FIG. 2. FIG. 2 is a schematic block diagram showing a digital channel generation apparatus in accordance with a preferred embodiment of the present invention. The set-top box 24 stored in the storage unit 21 comprises six sets of set-top box data used by Telecommunication Corporation, which are DSL4000 data 241, IP420 data 242, MOD201 data 243, MOD202 data 244, MOD203 data 245, and MSD508 data 246. Each set-top box data comprises the information of package type of a build-in browser and a look-up table recording the control codes in conjunction with corresponding functionalities of a remote controller. Because the message code definition concerning different package type of browser is different, the page control mode of the digital channel is also different. Consequently, the digital channel generation apparatus of the present invention stores information of various package types of the build-in browsers used by various set-top boxes so that the digital channel under processing is able to detect device model of the set-top box currently being used so as to make use of the set-top box data 24. Alternatively, users may select one device model of the set-top box manually while setting up the digital channel.

The electronic device data 25 comprises three different types of electronic device data concerning highly commercialized electronic devices for receiving digital information, which are the television data 251, the computer data 252, and the mobile phone data 253. Each electronic device data comprises the information of screen resolution of the corresponding display. The multimedia data 27 stored in the storage unit 21 comprises the multimedia files 271, the web-site data 272, the multicast data 273, and the picture files 274.

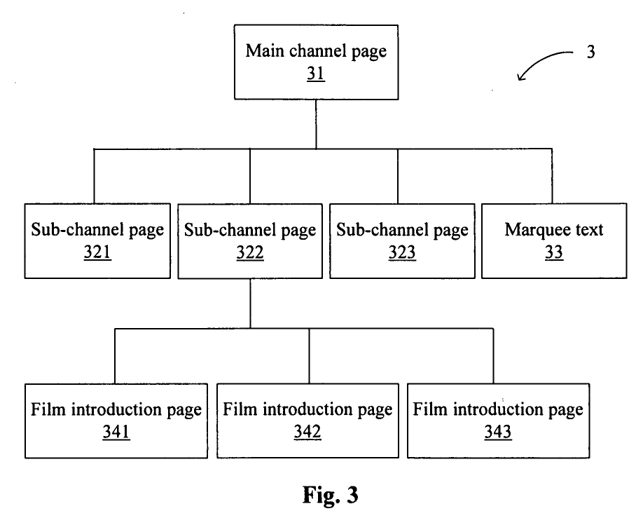

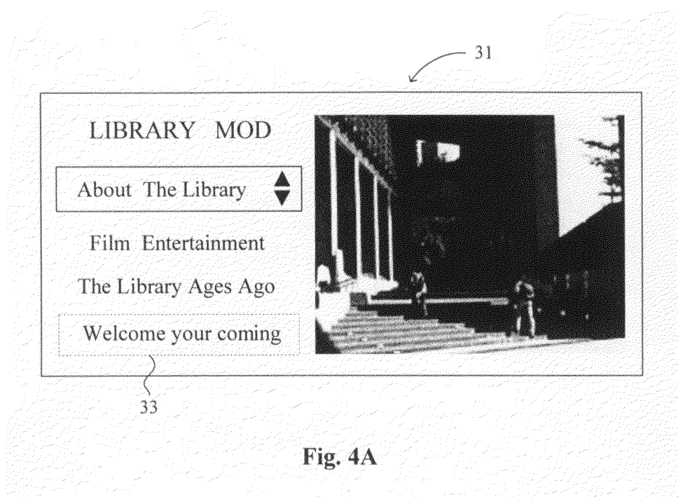

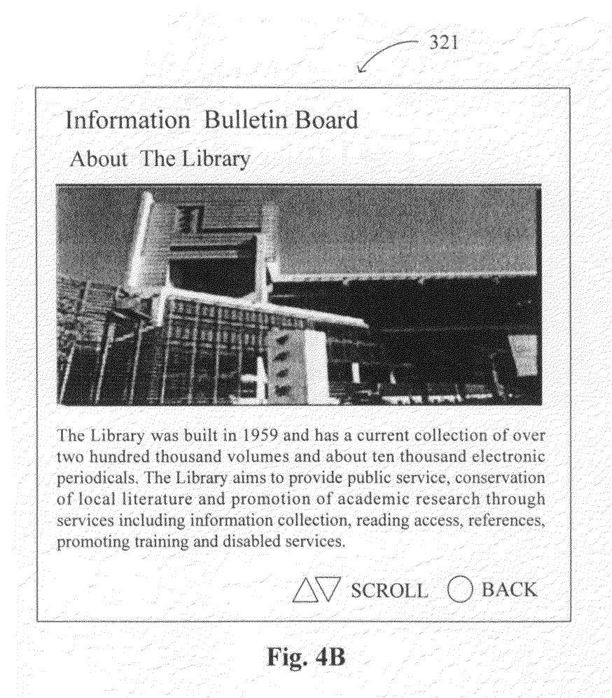

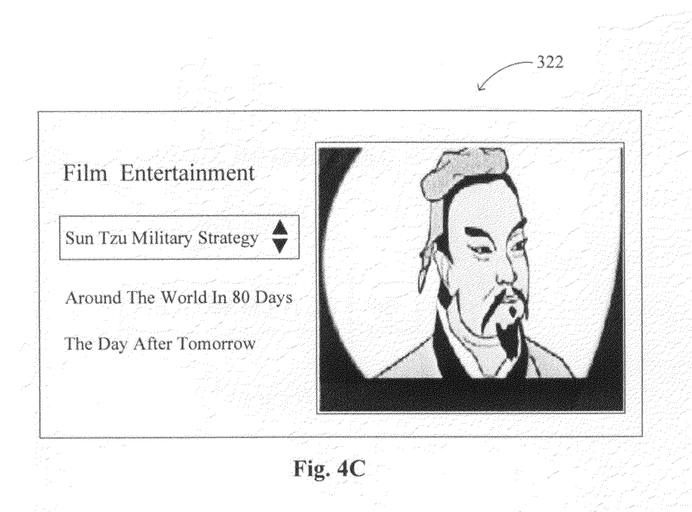

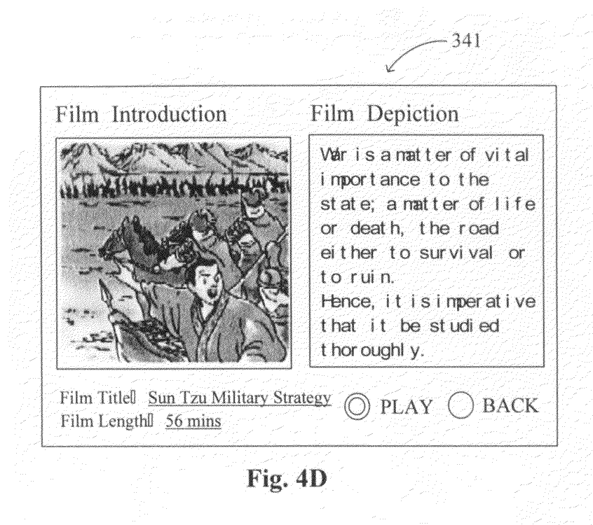

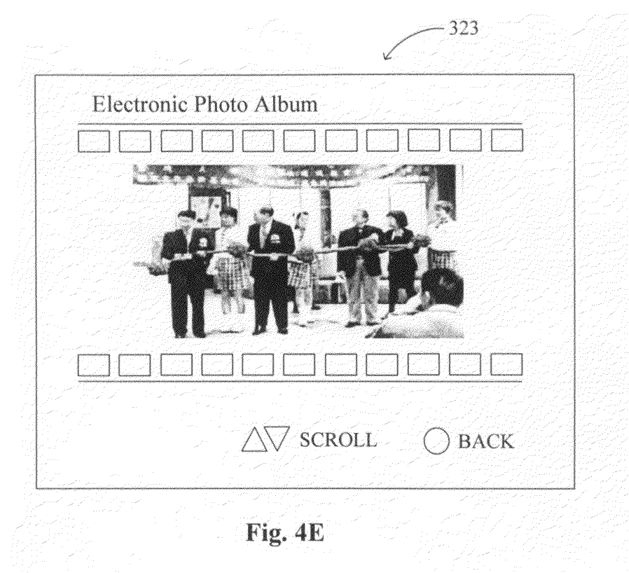

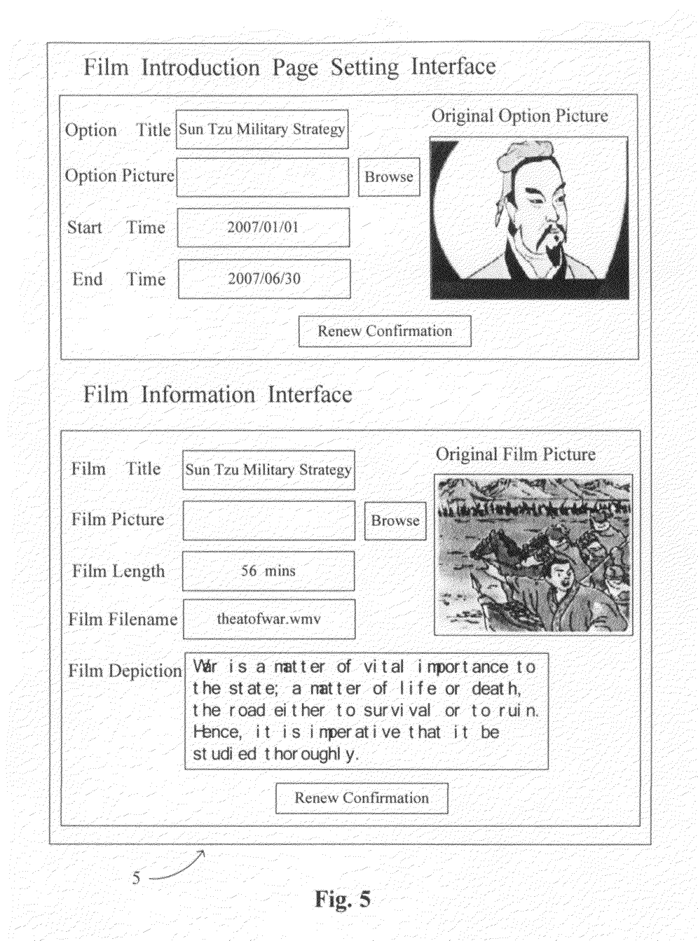

The user interface 22 provides users a functionality of selecting one electronic device data 259 corresponding to an electronic device used by users from the plurality of electronic device data 25. Furthermore, the user interface 22 provides users a functionality of inputting the set-up text 281 of a digital channel based on the channel set-up template 26. Moreover, the user interface 22 provides users a functionality of selecting the set-up picture 282 from the picture files 274 stored in the storage unit 21. All the above-mentioned functionalities are illustrated in FIG. 3, FIG. 4A through FIG. 4E, and FIG. 5.

Please refer to FIG. 3 and FIG. 4A through FIG. 4E. FIG. 3 shows a schematic exemplary structure of the channel set-up template in accordance with the present invention. The channel set-up template 3 comprises a main channel page 31, a sub-channel page 321, a sub-channel page 322, a sub-channel page 323, a marquee text 33, a film introduction page 341, a film introduction page 342, and a film introduction page 343. The main channel page 31 is linked to at least one sub-channel page. The page types of the sub-channel pages can be categorized into at least an information bulletin board page, a film content page, and an electronic photo album page. Each sub-channel page is selectively linked to at least one page according to the feature of the sub-channel page.

For instance, the sub-channel page 321 can be set to be an information bulletin board page, the sub-channel page 322 can be set to be a film content page, and the sub-channel page 323 can be set to be an electronic photo album page. The sub-channel page 322 can be further linked to the film introduction page 341, the film introduction page 342, and the film introduction page 343. The marquee text 33 can be linked to and displayed on the main channel page 31.

FIGS. 4A to 4E demonstrate an exemplary digital channel of a library based on the corresponding exemplary structure of the channel set-up template 3 shown in FIG. 3. The main channel page 31 displays the main content of the digital channel as shown in FIG. 4A. The digital channel of the library includes three digital subjects as “About The Library”, “Film Entertainment”, and “The Library Ages Ago”, which are provided for users to select desired subject. The marquee text 33 comprising text of “Welcome your coming” is displayed on the main channel page 31 animatedly. When users click the option of “About The Library”, the sub-channel 321 shown in FIG. 4B is linked and displayed. When users click the option of “Film Entertainment”, the sub-channel 322 shown in FIG. 4C is linked and displayed. When users click the option of “The Library Ages Ago”, the sub-channel 323 shown in FIG. 4E is linked and displayed. The sub-channel page 323 shows an electronic photo album concerning the option of “The Library Ages Ago”.

Please refer to FIG. 4B. FIG. 4B shows the information bulletin board page concerning the option of “About The Library”. The information bulletin board page 321 includes a description text, a library picture, an information title, a “SCROLL” option and a “BACK” option. When users click the “SCROLL” option, the information bulletin board page will switch to another set of the description text, the library picture, and the information title.

Please refer to FIG. 4C. FIG. 4C shows the film content page concerning the option of “Film Entertainment”. The film content page 322 displays options of “Sun Tzu Military Strategy”, “Around The World In 80 Days” and “The Day After Tomorrow”, and a picture concerning the option of “Sun Tzu Military Strategy” selected by the option cursor. When users click an option, a corresponding film introduction page is linked and displayed. Please refer to FIG. 4D. FIG. 4D shows a film introduction page concerning the option of “Sun Tzu Military Strategy”. The film introduction page 341 displays a film picture, a film depiction, a film title, a film length, a “PLAY” option and a “BACK” option. When users click the “PLAY” option, the film of “Sun Tzu Military Strategy” is played. When users click the option of “Sun Tzu Military Strategy” in FIG. 4C, the introduction page 341 shown in FIG. 4D is linked and displayed. When users click the option of “Around The World In 80 Days” in FIG. 4C, the introduction page 342 is linked and displayed. When users click the option of “The Day After Tomorrow” in FIG. 4C, the introduction page 343 is linked and displayed.

Please refer to FIG. 5. FIG. 5 shows a schematic diagram of the user interface of the digital channel generation apparatus in accordance with a preferred embodiment of the present invention. The user interface 5 is utilized to set up a film introduction page. The user interface 5 provides a plurality of columns for users to enter option title, start time, end time, film title, film length, and film depiction. Furthermore, the user interface 5 provides browse functions so that users can select option picture file and film picture file to be displayed and select multimedia data to be broadcasted through browsing options. The filled text and the selected picture file are displayed in the pages of FIG. 4C and FIG. 4D. The start time and the end time mean that the selected film is available for entertainment only in the time duration between the start time and the end time. When users select the multimedia files 271 as the multimedia data, the digital channel broadcasts audio-video content based on a file play mode. When users select the web site data 272 as the multimedia data, the digital channel links the web site and broadcasts audio-video content based on a real-time streaming play mode. When users select the multicast data 273 as the multimedia data, the digital channel links the multicast web site and broadcasts audio-video content based on a multicast streaming play mode.

Based on the above description, users can set up a digital channel through the user interface 22 based on the channel set-up template 26 by inputting the set-up text 281 and selecting the set-up picture 282 from the picture files 274 stored in the storage unit 21. That is to say, any user without knowing how to program is able to set up a digital channel. Therefore, the processing unit 23 is able to generate the digital channel for broadcasting multimedia data 27 based on the selected electronic device data 259, the set-top box data 24, the channel set-up template 26, the set-up text 281 and the selected set-up picture 282. Furthermore, the processing unit 23 is able to adjust the page layout of the digital channel according to the display resolution of the selected electronic device data 259.

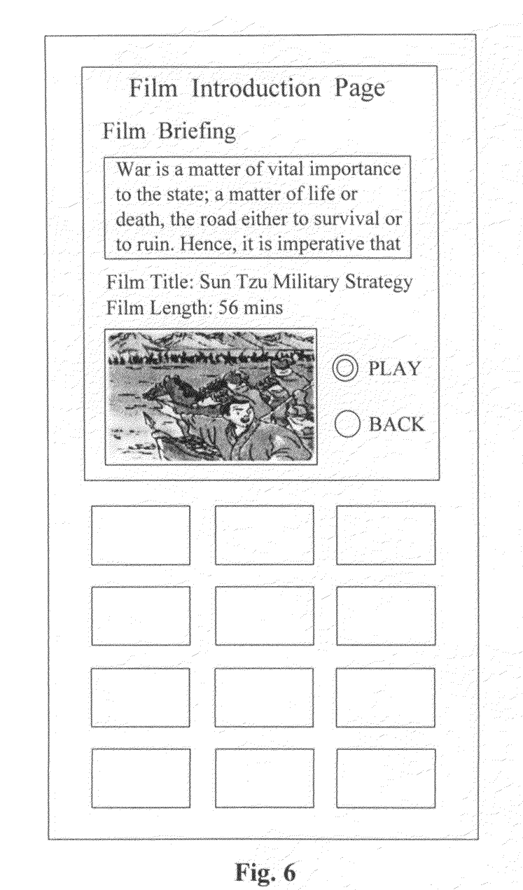

Please refer to FIG. 6. FIG. 6 is a schematic diagram showing an exemplary channel page of a mobile phone generated by the digital channel generation apparatus in accordance with the present invention. Because the mobile phone data 253 is selected as the desired electronic device data, the processing unit 23 adjusts the page layout of the digital channel based on the screen resolution of the mobile phone recorded in the mobile phone data 253. Compared with the page screen shown in FIG. 4D being used for a television display, the processing unit 23 shrinks the displayed picture to comply with the lower screen resolution of the mobile phone. Furthermore, because the aspect ratio of the screen of the mobile phone is higher than that of the television, the processing unit 23 makes a longitudinal layout for the film picture, the film briefing, the film title, the film length, the “PLAY” option and the “BACK” option so that the displayed screen is clearer for users.

While the invention has been shown and described with respect to the preferred embodiments of the present invention, it will be understood by those skilled in the art that various changes and modifications may be made without departing from the spirit and scope of the invention as defined in the following claims.

What is claimed is:

1. A digital channel generation apparatus for setting up a digital channel by a user, comprising:
a storage unit for storing a plurality of set-top box data, a plurality of electronic device data, a plurality of multimedia data, and at least one channel set-up template;
a user interface, coupled to the storage unit, for providing the user a functionality of selecting at least one electronic device data from the plurality of electronic device data, and for providing the user a functionality of inputting a set-up data of the digital channel based on the channel set-up template; and
a processing unit, coupled to the user interface, for generating the digital channel to broadcast the plurality of multimedia data based on the selected electronic device data, the plurality of set-top box data, the channel set-up template and the set-up data.

2. The digital channel generation apparatus of claim 1, wherein the set-top box data comprises the model number of the set-top box, the information of a browser used by the set-top box, and the information of a remote controller used by the set-top box.

3. The digital channel generation apparatus of claim 1, wherein the electronic device data is a television data, a computer data, or a mobile phone data.

4. The digital channel generation apparatus of claim 3, wherein the electronic device data comprises the information of display resolution of the corresponding electronic device.

5. The digital channel generation apparatus of claim 4, wherein the processing unit adjusts the page layout of the digital channel based on the information of display resolution of the selected electronic device data.

6. The digital channel generation apparatus of claim 1, wherein the channel set-up template comprises a main channel page, a sub-channel page, a marquee text or a film introduction page.

7. The digital channel generation apparatus of claim 1, wherein the multimedia data comprises a multimedia file, a web site data, a multicast data or a picture file.

8. The digital channel generation apparatus of claim 1, wherein the user interface further provides the user a functionality of selecting a set-top box data from the plurality of set-top box data, and the processing unit generates the digital channel for broadcasting the plurality of multimedia data based on the selected electronic device data, the selected set-top box data, the channel set-up template and the set-up data.
